(19) United States
(12) Patent Application Publication
(10) Pub. No.: US 2012/0325879 A1
(43) Pub. Date: Dec. 27, 2012

(54) Device For Attaching A Cell Phone To A Bicycle

(76) Inventor: Gary Olschansky, Cockeysville, MD (US)

(21) Appl. No.: 13/168,193

(22) Filed: Jun. 24, 2011

(51) Int. Cl. B62J 11/00

(52) U.S. Cl. 224/463

(57) ABSTRACT

A device for releasably securing a cell phone to a portion of the frame of a bicycle includes: (1) a flexible sheet material having edges, (2) flaps, each extending from one of the sheet material's edges and configured so as to be folded inward to cover a cell phone that has been placed on the sheet material, (3) flap fastener parts that are attached at locations on the flaps for releasably securing these flap fastener attachment locations to one another when these flaps have been folded inward to cover the cell phone, (4) a strap having a free end and an end that is attached to one of the flaps and a length between these ends which allows its free end to wrap around a portion of the bicycle's frame and be returned to the device, (5) strap fastener parts that are attached at locations on the strap for releasably securing these strap fastener attachment locations to one another after the strap has been wrapped around the bicycle's frame, and (6) memory foam attached to the bottom surface of the sheet material and configured so as to minimize the vibrations experienced by the bicycle's frame from being transmitted to a cell phone folded within the device.

### BACKGROUND OF THE INVENTION

1. Field of the Invention

The present invention relates generally to package and article carriers of the type that are attached to a cycle. More particularly, the present invention relates to an improved device for attaching a cell phone to a bicycle.

2. Description of the Related Art

Package and article carriers of the type that are attached to a cycle are well known. See, for example, U.S. Pat. Nos. 6,032,841, 7,191,924 and D621,608. Carriers for cell phones are also well known; see, for example, U.S. Pat. Nos. 6,568,576 and 6,315,182.

Casual to intermediate bicycle riders generally carry a cell phone with them while riding so that, in the event of an emergency, they can contact someone for help. Although there are numerous bicycle packs, attachments and devices that can be used for holding a cell phone, many of these are either bulky or awkward to use as they are typically designed principally for holding other items of interest to the bicycle rider such as tire tubes, tools, etc. and therefore such devices may often not the safest storage containers for cell phones as interactions with the other items in the devices can damage a cell phone.

As a result of not having a good or acceptable location or device for storing their cell phones, many riders will often decide to place their cell phone in a pocket of their clothing. However, such a cell phone location is often uncomfortable and can result in the phone becoming saturated in sweat. It can also potentially raise a serious safety issue for the rider as placing a cell phone in a clothing pocket can make the phone too accessible and thereby increase the possibility of the hazardous situation arising in which the bicycle rider tries to pull out the cell phone and use it while riding.

Thus, despite much prior art in this area, there is still the need for an improved device for attaching a cell phone to a bicycle—i.e., a device for easily, detachably fastening a cell phone to a bicycle such that the device provides a safe storage location for the cell phone while also being prominently visible and accessible without interfering with a bicycle rider's pedaling of the bicycle.

### SUMMARY OF THE INVENTION

Recognizing the need for the development of an improved device for attaching a cell phone to a bicycle, the present invention is generally directed to satisfying the needs set forth above and overcoming the problems and disadvantages exhibited by devices which are often used by bicycle riders for storing a cell phone.

In accordance with a preferred embodiment of the present invention, an improved device for releasably securing a cell phone to a portion of the frame of a bicycle comprises: (1) a body having edges and formed of a flexible sheet material, (2) one or more flaps, each extending from one of the body's edges and having a configuration that allows each of the flaps to be folded inward from its edge so as to cover and protect a cell phone that has been placed on the top surface of the body, (3) flap fastener parts, each of these being attached at a location on the flaps for releasably securing these flap fastener attachment locations to one another when these flaps have been folded inward to cover and protect the cell phone, (4) a strap having a free end and an attached end and a specified length between these ends, wherein the attached end is attached to one of the flaps and wherein the strap's length is chosen so as to allow its free end to be extended from the device so as to wrap around a portion of the frame of a bicycle and then be returned to the device, (5) strap fastener parts, each of these being attached at a location on the strap for releasably securing these strap fastener attachment locations to one another after the strap's free end has been wrapped around a portion of the frame of a bicycle and then returned to the device so as to secure the strap to the bicycle, and (6) a member of memory foam attached to the bottom surface of the body and configured so as to minimize the vibrations experienced by a bicycle frame from being transmitted to a cell phone which has been placed on the top surface of the body and about which the flaps have been folded and the strap used to attach the device with its enclosed cell phone to the bicycle frame.

Thus, there has been summarized above (rather broadly and understanding that there are other preferred embodiments which have not been summarized above) the present invention in order that the detailed description that follows may be better understood and appreciated.

### BRIEF DESCRIPTION OF THE DRAWINGS

FIG. 1 is a perspective, top view of the present invention on which a cell phone has been placed.

FIG. 2 is a perspective, bottom view of the present invention.

FIG. 3 is a perspective view of the present invention which enfolds a cell phone and has, utilizing its strap, been secured to a portion of a bicycle's frame.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

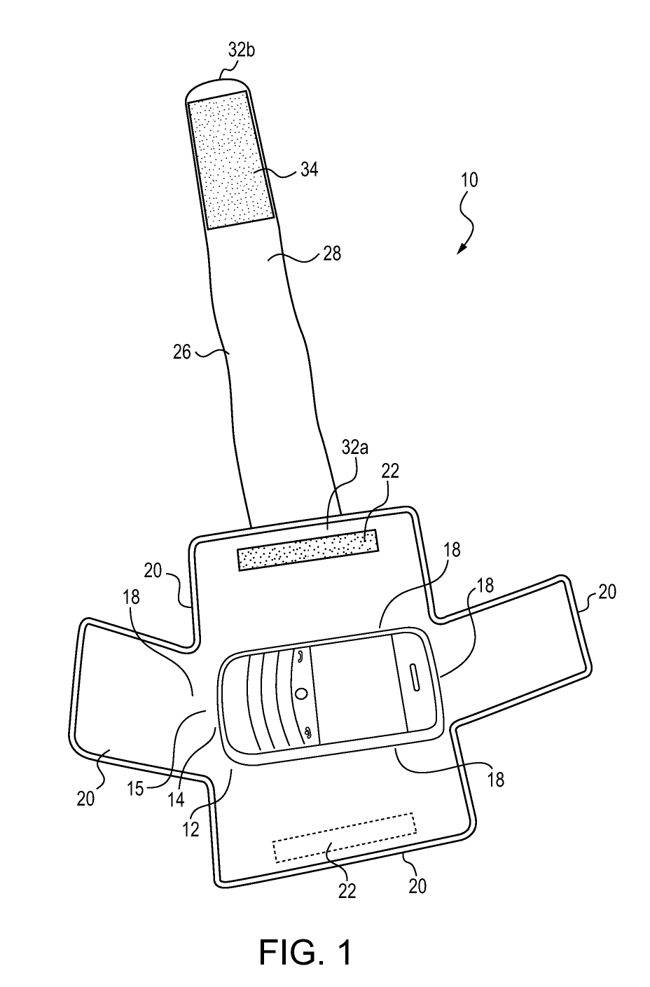

Referring to FIG. 1, there is illustrated a preferred embodiment of the present invention 10 in the form of an improved device for attaching a cell phone to a bicycle. The cell phone is assumed to be of the standard size that has an operational top surface which has a prescribed surface area whose value is such that the cell phone can easily be held in the palm of a person's hand. Meanwhile the bicycle is assumed to be of the type that has a frame which includes at least one piece of horizontally-oriented tubing that connects the front and rear wheels of the bicycle.

The present invention 10 is seen to consist of a body 12 that takes the form of a flexible sheet material that has top 14 and bottom 16 surfaces that include a number of edges 18. As shown in FIG. 1, the body has two pairs of opposite edges from which extend flaps 20. These flaps 20 and the centrally oriented sheet material or body 12 are each seen to be configured and sized so that each of them can individually cover and protect the cell phone. For example, the cell phone is protected when these flaps 20 are folded over onto the top of the cell phone's operational surface.

While FIG. 1 shows the present invention to have four flaps, it is to be understood that a lesser or greater number of flaps could have been used and such an embodiment would fall within the scope of the present invention. Meanwhile, it is also to be understood that there are many alternative ways to describe the flexible sheet material that is used in the present invention. For a first example, the embodiment shown in FIG. 1 could also be described as a continuous piece of sheet material that has been cut so that its overall shape is similar to that of a “+” sign or a “cross” (such a description thereby includes the flaps as part of the sheet material). For a second example, this embodiment could be described as a body having opposite end portions and an intermediate portion which has a pair of opposite edges from which extend flaps, and wherein these end portions and the flaps each having a configuration that allow them to be folded over a cell phone's operational surface.

The flexible sheet material of the present invention is preferably a resilient or elastic material such as rubber or neoprene; although it will be appreciated that non-resilient or non-elastic materials such as plastic, leather, webbing and other flexible materials may be used. A fabric overlay 15 may also be provided, e.g., along the surfaces of the body and/or flaps for additional strength and aesthetic reasons. Such an overlay can also be used to provide the part of the body or flap which the overlay covers with high-friction, non-skid properties so that the cell phone and device do not slip relative to their original orientations/locations on a bicycle. Alternatively, the sheet material itself may be fabricated so as to have such surface properties. Such fabric overlays and sheet material fabrication methods are well known in the arts and therefore will not be discussed further herein.

To ensure that the flaps 20 of the present invention stay in place once they are folded over the cell phone, two-part fasteners 22 are attached at various location on either the top or bottom surfaces of the flaps 20 for releasably securing these attachment locations to one another so as to cover and protect the cell phone. Preferably, these fastener parts are hook-and-loop-type fasteners. However, other types of fasteners could also conceivably be used, such as buttons, snaps, buckles, hooks, latches and the like.

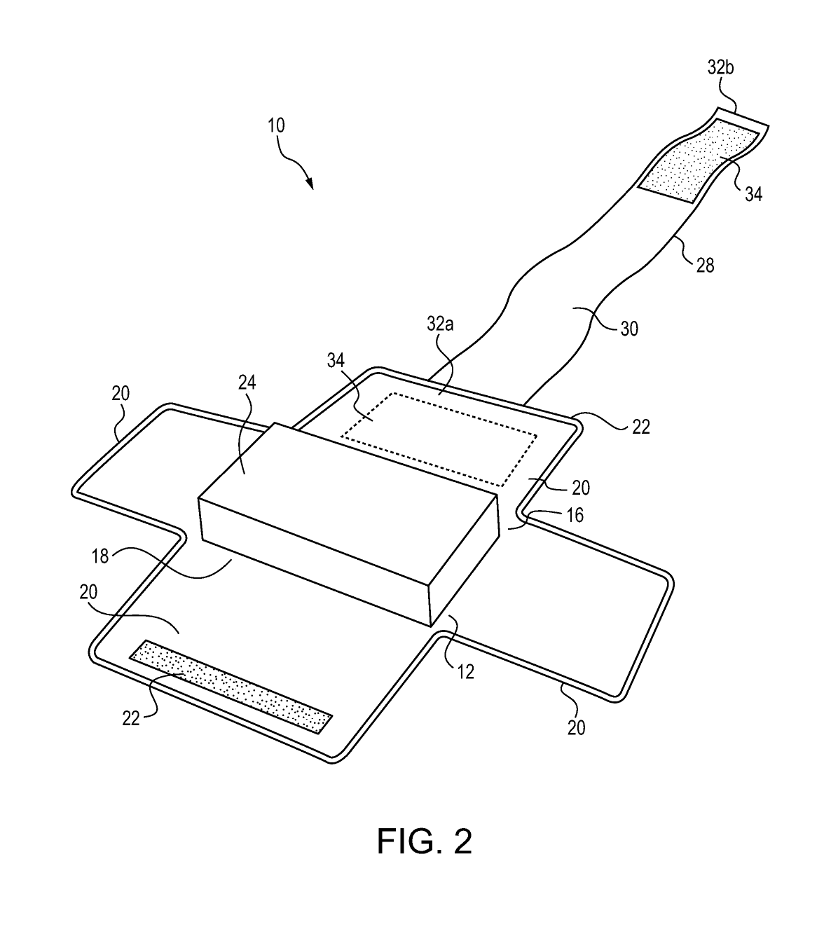

To provide shock adsorption capability (i.e., to minimize the vibrations of the bicycle frame from being transmitted to a cell phone) for the present invention, a member 24 of memory foam or visco-elastic polyurethane foam is attached to the bottom surface 16 of the body 12 as it is this surface that will be placed next to a portion of the bicycle's frame to which this protective covering is to be releasably affixed. See FIG. 2. This member 24 is preferably configured and sized so that it covers essentially the total area of the body's bottom surface. This member may or may not be covered with a fabric overlay as a means of affixing it to the body's bottom surface.

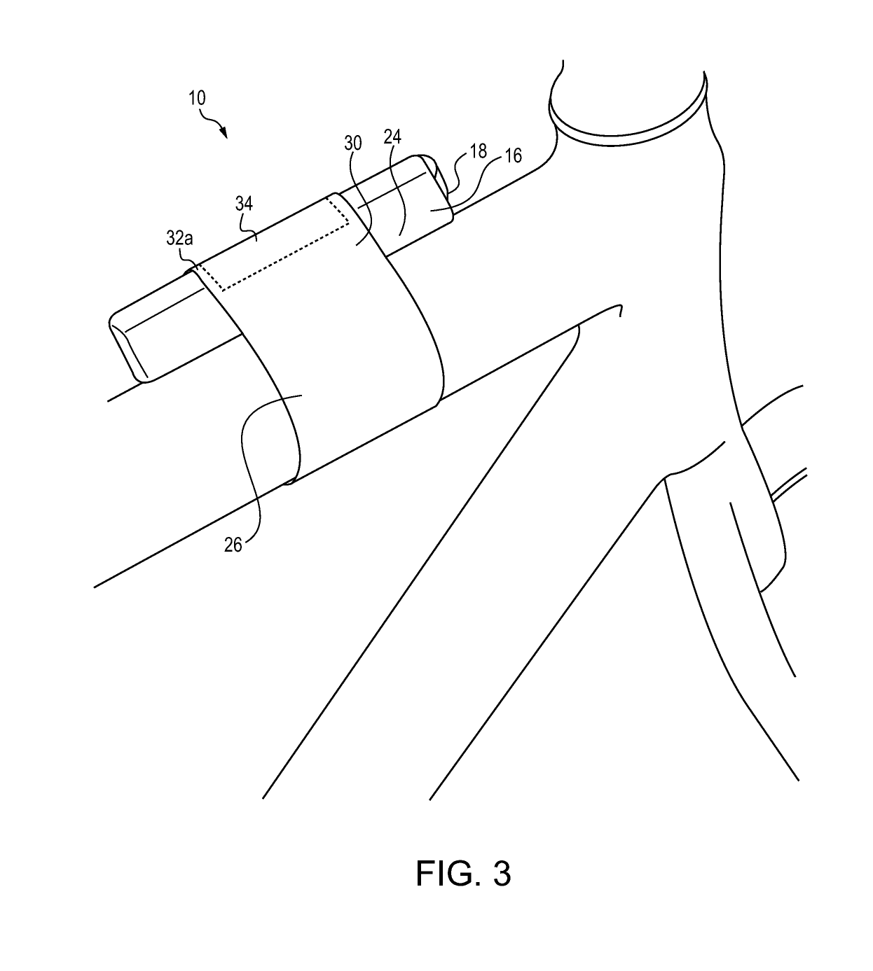

To attach this body 12 or protective covering to the frame of a bicycle, the present invention includes an elongated strap 26 that is attached to the bottom surface of the body 12 or one of its flaps 20. This strap has a top 28 and a bottom 30 surface and opposite ends 32, one 32a of which is attached to the protective covering. The strap also has a specified length which is such so as to allow its free end 32b to be wrapped around a portion of the bicycle's frame and then brought back to the protective covering and secured to it. This is achieved by utilizing a number of fastener parts 34, each of which is attached to the strap at a location on either its top or bottom surfaces for releasably securing these strap attachment locations to one another. Preferably, these fastener parts are also hook-and-loop-type fasteners. See FIG. 3.

The foregoing is considered as illustrative only of the principles of the invention. Further, since numerous modifications and changes will readily occur to those skilled in the art, it is not desired to limit the invention to the exact construction and operation shown and described herein. Accordingly, all suitable modifications and equivalents may be resorted to, falling within the scope of the invention that is hereinafter set forth in the claims to the invention.

I claim:

1. A device for releasably securing a cell phone to a portion of the frame of a bicycle, wherein said cell phone of the type having an operational surface with a prescribed surface area, said device comprising:
a body formed of a flexible sheet material and having a top and a bottom surface and a plurality of edges,
a plurality of flaps, each having a top and a bottom surface and extending from one of said plurality of edges,
a pair of flap fastener parts, each of said flap fastener parts attached to one of said flaps at a location chosen from the group of the top and bottom surfaces of said flaps, for releasably securing said flap fastener attachment locations to one another when said flaps are folded inward to cover and protect said cell phone,
a strap having a top and a bottom surface and a free end and an attached end and a specified length between said ends, wherein said attached end being attached to one of said flaps,
a plurality of strap fastener parts, each of said strap fastener parts being attached to said strap at a location chosen from the group of the top and bottom surfaces of said strap for releasably securing said strap fastener attachment locations to one another after said free end has been wrapped around a portion of the frame of said bicycle and then returned to said device so as to secure said strap to said bicycle, and
a member of memory foam attached to the bottom surface of said body.

2. A device according to claim 1, wherein said flaps each having a configuration that is sized so that each of said flaps protects said cell phone operational surface when said flap is folded inward on said edge from which said flap extends so as to cover said cell phone operational surface.

3. A device according to claim 1, wherein said strap length chosen so as to allow said strap free end to extend from said device so as to wrap around a portion of the frame of said bicycle and then be returned to said device.

4. A device according to claim 2, wherein said strap length chosen so as to allow said strap free end to extend from said device so as to wrap around a portion of the frame of said bicycle and then be returned to said device.

5. A device according to claim 1, wherein said member having a configuration chosen so as to minimize the vibrations of the bicycle frame to which said strap is attached from being transmitted to a cell phone which has been placed on the top surface of said body and about which said flaps have been folded and said strap used to attach said device with its enclosed cell phone to said bicycle frame.

6. A device according to claim 2, wherein said member having a configuration chosen so as to minimize the vibrations of the bicycle frame to which said strap is attached from being transmitted to a cell phone which has been placed on the top surface of said body and about which said flaps have been folded and said strap used to attach said device with its enclosed cell phone to said bicycle frame.

7. A device according to claim 3, wherein said member having a configuration chosen so as to minimize the vibrations of the bicycle frame to which said strap is attached from being transmitted to a cell phone which has been placed on the top surface of said body and about which said flaps have been folded and said strap used to attach said device with its enclosed cell phone to said bicycle frame.

8. A device according to claim 4, wherein said member having a configuration chosen so as to minimize the vibrations of the bicycle frame to which said strap is attached from being transmitted to a cell phone which has been placed on the top surface of said body and about which said flaps have been folded and said strap used to attach said device with its enclosed cell phone to said bicycle frame.

9. A device according to claim 1 further comprising a fabric overlay covering a device surface chosen from the group of body and flap surfaces and having a configuration chosen so as to provide said covered surface with high-friction, non-skid properties.

10. A device according to claim 2 further comprising a fabric overlay covering a device surface chosen from the group of body and flap surfaces and having a configuration chosen so as to provide said covered surface with high-friction, non-skid properties.

11. A device according to claim 3 further comprising a fabric overlay covering a device surface chosen from the group of body and flap surfaces and having a configuration chosen so as to provide said covered surface with high-friction, non-skid properties.

12. A device according to claim 4 further comprising a fabric overlay covering a device surface chosen from the group of body and flap surfaces and having a configuration chosen so as to provide said covered surface with high-friction, non-skid properties.

13. A device according to claim 5 further comprising a fabric overlay covering a device surface chosen from the group of body and flap surfaces and having a configuration chosen so as to provide said covered surface with high-friction, non-skid properties.

14. A device according to claim 6 further comprising a fabric overlay covering a device surface chosen from the group of body and flap surfaces and having a configuration chosen so as to provide said covered surface with high-friction, non-skid properties.

15. A device according to claim 7 further comprising a fabric overlay covering a device surface chosen from the group of body and flap surfaces and having a configuration chosen so as to provide said covered surface with high-friction, non-skid properties.

16. A device according to claim 8 further comprising a fabric overlay covering a device surface chosen from the group of body and flap surfaces and having a configuration chosen so as to provide said covered surface with high-friction, non-skid properties.
